(19) United States
(12) Patent Application Publication
(10) Pub. No.: US 2024/0092367 A1
(43) Pub. Date: Mar. 21, 2024

(54) METHOD AND SYSTEM FOR INTOXICATION EXAMINATION OF OPERATORS FOR ASSET OPERATION AUTHORIZATION

(71) Applicant: HCL Technologies Limited, New Delhi (IN)

(72) Inventors: SANTOSH KUMAR SHARMA, Noida (IN); RAVINDRANATH L, Chennai (IN)

(21) Appl. No.: 18/243,686

(22) Filed: Sep. 8, 2023

(30) Foreign Application Priority Data
Sep. 16, 2022 (IN) 202211053063

(51) Int. Cl. B60W 40/08; G06V 20/52

(52) U.S. Cl. CPC B60W 40/08; G06V 20/52; B60W 2040/0809; B60W 2040/0836

(57) ABSTRACT

The invention relates to method and system for intoxication examination of an operator for operating an asset. The method includes receiving input data corresponding to the operator prior to operating the asset from one of an asset or a client device; determining an intoxication score of the operator based on the input data using a Machine Learning (ML) model; determining permissibility of operating an asset for the operator through a plurality of predefined rules using the ML model; assigning the asset to the operator when the asset operation is determined to be permissible for the operator; transmitting authorization information to the assigned asset; authorizing, by the asset, the operator to operate the asset based on the authorization information; upon authorization, monitoring in real-time, the operator during the asset operation from real-time video data of the operator to check for compliance of the asset operation with the conditions of operation.

### TECHNICAL FIELD

Generally, the invention relates to intoxication examination and more specifically, to a method and system for intoxication examination of an operator for operating an asset.

### BACKGROUND

Alcohol and Drugs Abuse (ADA) has been a major concern in our society, on the roads, and at workplaces. In our society, more than 40% of people are reported to consume alcohol and other substances. On the roads, Driving Under the Influence (DUI) is a major cause of road accidents and subsequent loss of life and damage to properties. Many governments across the world have framed regulations and guidelines to deal with the problem of Alcohol and Drugs Abuse (ADA). The World Health Organization (WHO) has recommended a general guideline to member countries for DUI countermeasures. Recommendations include enacting and enforcing laws for BAC limits and penalties for DUI. As a result, encouraging results have been observed in many countries on measures taken to reduce a number of alcohol-impaired drivers by enacting stricter laws with higher penalties and fines. Data gathered also showed gradual reduction in number of deaths due to various road safety measures including increased use of seat belts, manage speed limits, and reduced number of alcohol-impaired drivers in traffic. For example, the mandatory Ignition Interlock Device (IID) program is introduced in some countries for DUI offenders.

Further, for example, a “Safe Driving Manager System” is introduced in Japan for all enterprises operating 5 or more vehicles. A “Driver Alcohol Detection System for Safety (DADSS)” that is a public-private partnership program between the “Automotive Coalition for Traffic Safety (ACTS) and National Highway Traffic Safety Administration (NHTSA)” have been launched with the aim to develop alcohol detection systems that may passively and unobtrusively detect driver's Blood Alcohol (BAC) level and prevent from driving when it is above a legal limit. At the workplaces, Alcohol and Drugs Abuse (ADA) poses serious issues to businesses including injury to self and others, productivity loss, damage to property, compensations, liabilities, increased insurance cost, litigations, and the like.

Various systems are available for intoxication examination that may perform intoxication monitoring based on breath air analysis or sensing through skin, drowsiness and alertness monitoring based on eyes activities, operator identification based on biometric and visual recognition, allowing machine operation based on intoxication levels assessment, and safety compliance monitoring while operating a machine. The available systems have solved variety of problem areas with general objective to improve safety of the operator (i.e., a user), properties, and in many cases other people (i.e., co-passengers, pedestrians, co-workers, and public) too. However, the available systems still lack in providing solutions for the enterprises in creating and maintaining a drug free workplace.

### SUMMARY

In one embodiment, a method for intoxication examination of an operator for operating an asset is disclosed. The method may include receiving input data corresponding to the operator prior to operating the asset from at least one of an asset or a client device. It should be noted that the asset may be in a locked state. The asset may be inaccessible by the operator in the locked state. The method may further include determining an intoxication score of the operator based on the input data using a Machine Learning (ML) model. The method may further include determining, using the ML model, permissibility of operating an asset for the operator through a plurality of predefined rules. In one embodiment, the permissibility may be determined based on the intoxication score of the operator. It should be noted that the asset operation may be permissible when the intoxication score of the operator is above a predefined threshold score required for operating the asset. In one embodiment, the permissibility may be determined based on a plurality of responses corresponding to an examination questionnaire received from the operator. The examination questionnaire may include a plurality of questions, and the asset operation may be permissible when the operator correctly answers more than a predefined threshold number of questions in the questionnaire. The method may further include assigning the asset to the operator when the asset operation is determined to be permissible for the operator. The method may further include transmitting authorization information to the assigned asset. The authorization information may include operator details, a class of the asset, conditions of operation, a validity period, an issuer, and checksum. The method may further include authorizing, by the asset, the operator to operate the asset based on the authorization information. It should be noted that, upon successful authorization, the asset may be in an unlocked state, and in the unlocked state the asset may be accessible by the operator. The method may further include upon authorization, monitoring in real-time, the operator during the asset operation from real-time video data of the operator to check for compliance of the asset operation with the conditions of operation.

In another embodiment, a system for intoxication examination of an operator for operating an asset is disclosed. The system may include a processor and a memory communicatively coupled to the processor, which, on execution, may cause the processor to receive input data corresponding to the operator prior to operating the asset from at least one of an asset or a client device. The asset may be in a locked state, and in the locked state the asset may be inaccessible by the operator. The processor-executable instructions, on execution, may further cause the processor to determine an intoxication score of the operator based on the input data using a Machine Learning (ML) model. The processor-executable instructions, on execution, may further cause the processor to determine, using the ML model, permissibility of operating an asset for the operator through a plurality of predefined rules. In one embodiment, the permissibility may be determined based on the intoxication score of the operator. It should be noted that the asset operation may be permissible when the intoxication score of the operator is above a predefined threshold score required for operating the asset. In another embodiment, the permissibility may be determined based on a plurality of responses corresponding to an examination questionnaire received from the operator. The examination questionnaire may include a plurality of questions, and the asset operation may be permissible when the operator correctly answers more than a predefined threshold number of questions in the questionnaire. The processor-executable instructions, on execution, may further cause the processor to assign the asset to the operator when the asset operation is determined to be permissible for the operator. The processor-executable instructions, on execution, may further cause the processor to transmit authorization information to the assigned asset. The authorization information may include operator details, a class of the asset, conditions of operation, a validity period, an issuer, and checksum. The processor-executable instructions, on execution, may further cause the processor to authorize, by the asset, the operator to operate the asset based on the authorization information. Upon successful authorization, the asset may be in an unlocked state. In the unlocked state, the asset may be accessible by the operator. The processor-executable instructions, on execution, may further cause the processor to monitor, in real-time, the operator during the asset operation from real-time video data of the operator to check for compliance of the asset operation with the conditions of operation, upon authorization.

In yet another embodiment, a non-transitory computer-readable medium storing computer-executable instruction for intoxication examination of an operator for operating an asset is disclosed. The stored instructions, when executed by a processor, may cause the processor to perform operations including receiving input data corresponding to the operator prior to operating the asset from at least one of an asset or a client device. The asset may be in a locked state, and in the locked state the asset may be inaccessible by the operator The operations may further include determining an intoxication score of the operator based on the input data using a Machine Learning (ML) model. The operations may further include determining, using the ML model, permissibility of operating an asset for the operator through a plurality of predefined rules. In one embodiment, the permissibility may be determined based on the intoxication score of the operator. It should be noted that the asset operation may be permissible when the intoxication score of the operator is above a predefined threshold score required for operating the asset. In another embodiment, the permissibility may be determined based on a plurality of responses corresponding to an examination questionnaire received from the operator. The examination questionnaire may include a plurality of questions, and the asset operation may be permissible when the operator correctly answers more than a predefined threshold number of questions in the questionnaire. The operations may further include assigning the asset to the operator when the asset operation is determined to be permissible for the operator. The operations may further include transmitting authorization information to the assigned asset. The authorization information may include operator details, a class of the asset, conditions of operation, a validity period, an issuer, and checksum. The operations may further include authorizing the operator to operate the asset based on the authorization information, wherein upon successfully authorizing, the asset is in an unlocked state. Upon successful authorization, the asset may be in an unlocked state. In the unlocked state, the asset may be accessible by the operator. The operations may further include monitoring, in real-time, the operator during the asset operation from real-time video data of the operator to check for compliance of the asset operation with the conditions of operation, upon authorization.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals

FIG. 1 illustrates a system for intoxication examination of an operator for operating an asset, in accordance with some embodiments of the present disclosure.

FIG. 2 illustrates a block diagram of an exemplary system for operator's intoxication examination and operation authorization, in accordance with some embodiments of the present disclosure.

FIG. 3 illustrates a block diagram of another exemplary system for operator's intoxication examination and operation authorization, in accordance with some embodiments of the present disclosure.

FIG. 4 illustrates a flowchart of an exemplary process of intoxication examination of an operator for operating an asset, in accordance with some embodiments of the present disclosure.

FIG. 5 illustrates a flowchart of an exemplary method of operating an asset through a self-intoxication examination by the operator, in accordance with some embodiments of the present disclosure.

FIG. 6 illustrates a flowchart of an exemplary method of operating an asset through a through a video call-based intoxication examination, in accordance with some embodiments of the present disclosure.

FIG. 7 illustrates a flowchart of an exemplary method operating an asset through an in-person intoxication examination, in accordance with some embodiments of the present disclosure.

FIG. 8 illustrates an exemplary client-side device representing alcohol detection through a self-examination test, in accordance with some embodiments of the present disclosure.

FIG. 9 illustrates an exemplary client-side device representing alcohol detection through a video-call examination with a manager/administrator, in accordance with some embodiments of the present disclosure.

FIG. 10 illustrates an exemplary client-side device representing submission of recoding of evidence video captured while performing a self-examination test, in accordance with some embodiments of the present disclosure.

FIG. 11 illustrates an exemplary client-side device representing submission of a test record from a plurality of test records, in accordance with some embodiments of the present disclosure.

FIG. 12 illustrates a Business Intelligence (BI) dashboard corresponding to an exemplary alcohol detection system, in accordance with some embodiments of the present disclosure.

FIG. 13 illustrates an exemplary table representing details of various alcohol testing records, in accordance with some embodiments of the present disclosure.

FIG. 14 illustrates details of an exemplary alcohol testing record, in accordance with some embodiments of the present disclosure.

FIG. 15 illustrates details of another exemplary alcohol testing record, in accordance with some embodiments of the present disclosure.

FIG. 16 illustrates a video call queue on a home screen of an exemplary client-side device, in accordance with some embodiments of the present disclosure.

FIG. 17 illustrates an exemplary client-side device representing submission of video recording captured while performing a video-call examination test, in accordance with some embodiments of the present disclosure.

FIG. 18 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions). Software and firmware can be stored on computer-readable storage media. Some other processes can be implemented using analog circuitry, as is well known to one of ordinary skill in the art. Additionally, memory or other storage, as well as communication components, may be employed in embodiments of the invention.

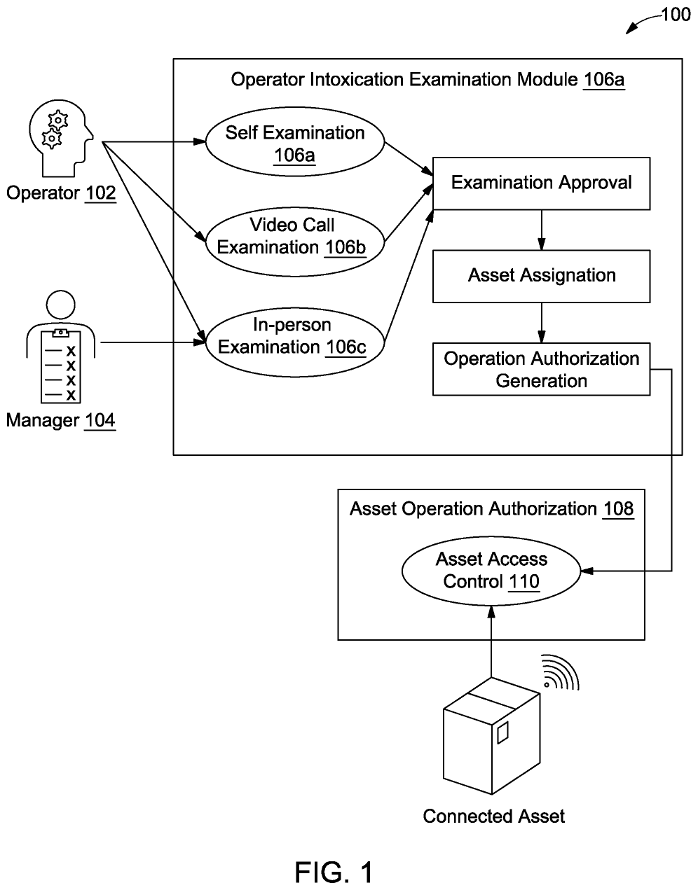

Referring now to FIG. 1, a system 100 for intoxication examination of an operator 102 for operating an asset is illustrated, in accordance with some embodiments of the present disclosure. The system 100 includes an operator 102, a manager 104 or an administrator, an intoxication examination module 106, and an asset operation authorization 108, and an asset access control module 110. The intoxication examination module 106 may perform an intoxication examination of the operator 1, 2 and based on that enables the system 100 to decide whether the operator is able to operate the asset. In an embodiment, the intoxication may be a self-examination test 106a. In an embodiment, the intoxication examination may be a video call examination 106b. In an embodiment, the intoxication examination may be an in-person examination 106c.

The system 100 may include a client-side device (not shown in FIG. 1) and a centralized server (not shown in FIG. 1). In some embodiments, the client-side device may enable an operator 102 to perform the self-examination test 106a. The centralized server may enable a manager/administrator 104 to review the self-examination test 106a taken by the operator 102. The client-side device may have a processor capable of running a client-side self-examination module, a display and a keyboard to interact with the operator 102, a video camera to capture a video while performing the self-examination test 106a, an intoxication detection device to measure presence of alcohol or drug, a data store, and network connectivity with the centralized server. The client-side device may include, but is not limited to, a smartphone, a laptop, a computer; any device integrated with the asset, a Digital Instrument Cluster (DIC) or the like.

Further, the centralized server may have a processor capable of running a server-side self-examination module, a display and a keyboard to interact with the operator 102, and a data store. The server may be an on-premises hosted or a cloud-hosted accessible from a workstation, a computer, a laptop, or the like. The system may also include an identity repository to store operator's and manager's/administrator's information. The identity repository may securely store operator credentials (for example, the login credentials). Also, in some embodiments, an Identity and Authorization Management (IAM) system may be used to enable Single Sign-On (SSO) and Multi-Factor Authentication (MFA), in place of the identity repository.

Further, the client-side device may require the operator 102 to sign-in using the credentials maintained in the identity repository. The client-side device may require a sign-in by the operator 102 if the operator's access is for the first time to establish network connectivity with the server for authentication. Once the operator 102 successfully signed-in, a hash of the credentials is securely stored in a cache that enables the operator 102 to sign-in again even if the client-device is not connected to network.

The client-side device may enable the operator 102 to initiate the self-examination test 106a and turn on the video camera for evidence recording. The operator 102 may be expected to remain within the video frame for entire duration of recording (i.e., from beginning to end). The client-side device may require the operator 102 to perform an operator verification through a biometric test and/or Identification Document (ID) verification. The biometric test may include, but is not limited to facial recognition, fingerprint matching, voice recognition, retina scanning, and the like. In some embodiments, the operator 102 may be allowed to use a valid ID proof issued by an employer (such as, an employee ID card), and a valid ID proof issued by a government agency (such as a driving license). In some embodiments, an Optical Character Recognition (OCR) technique, a barcode, and a QR Code may be used for ID verification.

The client-side device may require the operator 102 to perform a test using an intoxication detection device. The intoxication detection device may include a breath-based device (such as a breathalyzer), a touch-based device (such as an Alcometer), or a blood-based or saliva-based test-kit.

Further, in some embodiments, the client-side device may enable the operator 102 to initiate the video call examination 106b with the manager/administrator 104. The centralized server may enable the manager/administrator 104 to accept a video call from the operator 102, oversee the examination, and provide approval to operate the asset. The processor of the client-side device may be capable of running a client-side video-call examination module, a display and a keyboard to interact with the operator 102, a video camera for the video call, the intoxication detection device (such as the breathalyzer or the alcometer) to measure presence of alcohol and drug, and the network connectivity with the centralized server. The client-side device may be the smartphone, the computer; the laptop, the device integrated with the asset (e.g., the DIC), or the like.

The processor of the centralized server may be capable of running a server-side video-call examination software module, the display and the keyboard to interact with the operator 102, and the datastore. The server may be the on-premises hosted server or the cloud-hosted accessible from the workstation, the computer, the laptop, and the like. Further, the identity repository may be used to store the operator's and manager's/administrator's information. The identity repository securely stores the operator's credentials. In some embodiments, the identity repository may be replaced with the IAM system used to enable SSO and MFA.

The client-side device may require the operator 102 to sign-in using the credentials maintained in the identity repository. The client-side device may enable the operator 102 to initiate the video call with the manager/administrator 104. The centralized server may enable the manager 104 to accept the video call from the operator 102. The manager/administrator 104 may join the video call. The operator 102 may be expected to remain within the video frame for entire duration of video call from beginning to end.

In some embodiments, the client-side device may require the operator 102 to perform the biometric identification test and/or the ID verification. The biometric identification test may be performed based on at least one of the facial recognition techniques, the fingerprint matching, the voice recognition technique, and the retina scanning. The operator 102 may be allowed to use a valid ID proof issued by the employer (such as an employee ID card), valid ID proof issued by the government agency (such as the driving license, the voter ID). In some embodiments, at least one of the OCR techniques, the barcode, or the QR code may be used for the ID verification.

The client-side device may require the operator 102 to perform a test using the intoxication detection device. The intoxication detection device may include the breath-based device (such as the breathalyzer), the touch-based device (such as the alcometer), the blood-based or saliva-based test-kit, and the like.

In some embodiments, the client-side device may require the operator 102 to complete an examination questionnaire. The examination questionnaire may include questions and puzzles to assess the physical and mental fitment of the operator 102 required to safely carryout the operation. The manager/administrator 104 may verify and approve/reject the examination. It should be noted that the system 100 uses a plurality of business rules to check whether the operation is permissible. The business rules may factor the measurement from the intoxication detection device (such as breath alcohol content, blood alcohol content), and answers to the examination questionnaire. If the operation is permissible, the asset or a class of assets may be assigned to the operator 102. The asset assignation may be either done by the manager/administrator 104 or a self-assignation by the operator 102.

The asset may include the vehicle, the forklift, the crane, the aircraft, the watercraft, the machinery, and the like. Further, the asset operation authorization 108 may be generated and transmitted to the asset. The operation authorization 108 may include information of the operator, the asset or the class of asset, conditions of operation, validity period, the issuer, and checksum. The asset may verify the operation authorization 108 and allow the access to the operator 102.

The asset access control module 110 may be employed on the asset to validate the operation authorization 108, allow the operator 102 to access the asset, and ensure that the operation is performed as per predefined conditions of operation. It should be noted that logs of access and operations may be stored in an asset repository for compliance reporting and audit use. In some embodiments, the system 100 may save data to an examination repository. The data saved in the examination repository may include a recording of the video call examination 106b, measurements from the intoxication detection device, answers to the examination questionnaire, decision taken by the system 100 based on the business rules, and approval information by the manager/administrator 104. The manager/administrator 104 may review access to the asset. The manager/administrator may review the asset's access and operation's logs. Any discrepancy observed may be taken up as an input for further remedial actions and process improvements.

The in-person examination 106c may be implemented using the server-side system. The server-side system may enable the manager/administrator 104 to perform the in-person examination 106c with the operator 102. The server-side system may have the processor capable of running an in-person-examination module, the display and the keyboard to interact with the operator, the video camera for evidence recording, the intoxication detection device (such as the breathalyzer or the alcometer) to measure presence of alcohol and drug, and the datastore. The server of the server-side system may be the on-premises hosted or the cloud-hosted accessible from the workstation, the computer, the laptop, and the like. The operator 102 may in-person meet the manager/administrator 104. The manager/administrator 104 may turn on the video camera for evidence recording. The operator 102 may be expected to remain within the video frame for entire duration of examination from beginning to end.

The operator 102 may be required to perform the biometric identification test and/or the identity ID verification. The biometric identification test may be performed using at least one of the facial recognition techniques, the fingerprint matching, the voice recognition, the retina scanning, and the like. The operator 102 may be allowed to use the valid ID proof issued by the employer (such as the employee ID card) or valid ID proof issued by the government agency (such as the driving license). Further, the OCR, the barcode, and/or the QR Code may be used for ID verification.

Further, the operator 102 may be required to perform a test using the intoxication detection device. The intoxication detection device may include, but is not limited to, the breath-based device (for example, the breathalyzer), the touch-based device (for example, the alcometer), and the blood-based or the saliva-based test-kit. The manager/administrator 104 may verify and approve/reject the examination Further, the plurality of predefined business rules may be considered to decide whether the operation is permissible. The plurality of predefined business rules may factor measurement from the intoxication detection device (such as, breath alcohol content, and blood alcohol content), and answers to the examination questionnaire. If the operation is permissible, the manager 104 may be enabled to assign the asset or a class of the assets to the operator 102.

The asset may include the vehicle, the forklift, the crane, the aircraft, the watercraft, the machinery, or the like. Moreover, the asset operation authorization 108 may be generated and transmitted to the asset. The asset operation authorization 108 may include information of the operator, the asset or the class of assets, conditions of operation, validity period, the issuer, and checksum. The asset may verify the asset operation authorization 108 and allow the access to the operator 102. Further, the asset access control module 110 may be deployed on the asset to validate the asset operation authorization 108, allow the operator to access the asset, and ensure that the operation is performed as per the conditions of operation. Logs of access and operations may be stored in the asset repository for compliance reporting and audit use.

The system saves data to the examination repository. The examination data includes a recording of the in-person-examination, measurements from the intoxication detection device, answers to the examination questionnaire, decision taken by the system based on business rules, and approval information by the manager. The manager reviews access to the Asset. The manager reviews the asset's access and operations logs. Any discrepancy observed is taken up as input for further remedial actions and process improvements.

The system 100 provides proactive fitment screening of operators (for example, for employees) to carry out operations using the asset (i.e., a vehicle, a forklift, a crane, an aircraft, a watercraft, a machinery, and the like). In addition, the system 100 defines various workflows and approaches to perform the testing. Thus, the system 100 may offer a practical approach to monitor and manage intoxication levels of the operators.

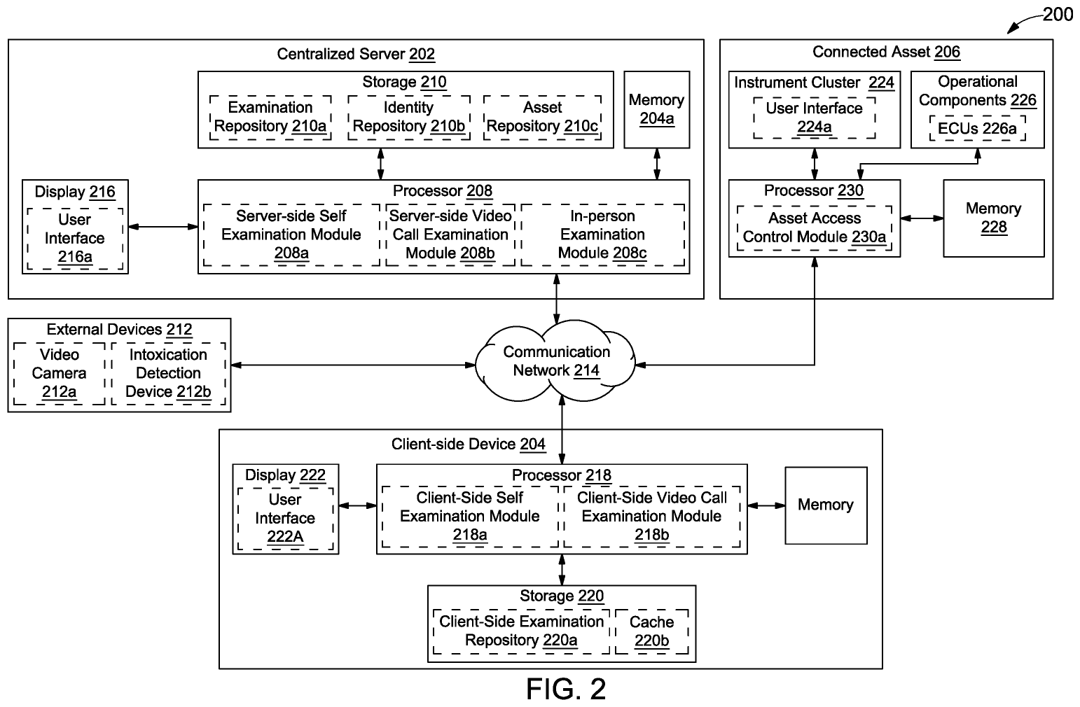

Referring now to FIG. 2, a system 200 for operator's intoxication examination and operation authorization is illustrated, in accordance with some embodiments of the present disclosure. FIG. 2 is explained in conjunction with FIG. 1. The system 200 includes a centralized server 202, a client-side device 204, and a connected asset 206.

In some embodiments, the centralized server 202 may enable a manager/administrator to review a self-examination test (same as the self-examination test 106a) taken by an operator (same as the operator 102). Further, in some embodiments, the centralized server 202 may enable the manager/administrator (same as the manager/administrator 104) to accept a video call from the operator, oversee the examination, and provide approval to operate the asset. Also, in some embodiments, the centralized server 202 may help in implementing an in-person examination (same as the in-person examination 106c). The centralized server 202 may be an on-premises hosted or a cloud-hosted accessible from a workstation, a computer, a laptop, or the like. The centralized server 202 may include a processor 208. The processor 208 may be capable of running a server-side self-examination module 208a, a server-side video-call examination module 208b, an in-person-examination module 208c, a display and a keyboard to interact with the operator, and a data store.

Further, the centralized server 202 may also include a storage 210. The storage 210 may include an examination repository 210a, an identity repository 210b, and an asset repository 210c. The examination repository 210a may be used to store data including a recording of the in-person-examination/self-examination/video-call examination, measurements from the intoxication detection device, answers to the examination questionnaire, decision taken by the system based on business rules, and approval information by the manager. The identity repository 210b may be used to store operator's and manager's/administrator's information. The identity repository 210b may securely store operator credentials (for example, the login credentials). Also, in some embodiments, an Identity and Authorization Management (IAM) system may be used to enable Single Sign-On (SSO) and Multi-Factor Authentication (MFA), in place of the identity repository 210b. Logs of access and operations may be stored in the asset repository 210c for compliance reporting and audit use.

The centralized server 202 may also be connected to external devices 212 (such as a video camera 212a, and an intoxication detection device 212b) through a communication network 214. The video camera 212a may be used to capture a video while performing the self-examination test, the video call with the manager/administrator, the evidence recording, the recording of the in-person-examination. Further, the intoxication detection device 212b may be used to measure presence of alcohol or drugs. The intoxication detection device 212b may include, but is not limited to, a Breathalyzer, an Alcometer, a biosensor, a thermal imaging device, sensor devices, touch-based devices, blood-based or saliva-based test kits. The external devices 212 may also be connected to the client-side device 204 through the communication network 214.

Further, the centralized server 202 may include a display 216. For example, in some embodiments, the display 216 may be used to display results of analysis. In some other embodiments, the display 216 may include a user interface 216a through which a user/administrator/operator may interact with system 200.

The client-side device 204 may include a processor 218, a storage 220, and a display 222. The client-side device 204 may include a memory 204a to store executable instructions to be processed by the communicatively coupled to the processor 218. The processor 218 may include a client-side self-examination module 218a and a client-side video call examination module 218b. The storage 220 may further include a client-side examination repository 220a, and a cache 220b.

In some embodiments, the client-side device 204 may enable an operator to perform the self-examination test. Further, in some embodiments, the client-side device 204 may enable the operator to initiate the video call examination with the manager/administrator. The client-side device 204 may include, but is not limited to, a smartphone, a laptop, a computer; any device integrated with the asset, a Digital Instrument Cluster (DIC) or the like. Further, in some embodiments, the client-side device 204 may require the operator to sign-in using the credentials maintained in the identity repository 210b. The client-side device 204 may require a sign-in by the operator if the operator's access is for the first time to establish network connectivity with the server for authentication. Once the operator successfully signed-in, a hash of the credentials is securely stored in the cache 220b that enables the operator to sign-in again even if the client-side device 204 is not connected to network.

The client-side device 204 may require the operator to perform an operator verification through a biometric test and/or Identification Document (ID) verification. The biometric test may include, but is not limited to facial recognition, fingerprint matching, voice recognition, retina scanning, and the like. In some embodiments, the operator may be allowed to use a valid ID proof issued by an employer (such as, an employee ID card), and a valid ID proof issued by a government agency (such as a driving license). In some embodiments, an Optical Character Recognition (OCR) technique, a barcode, and a QR Code may be used for ID verification.

In some embodiments, the client-side device 204 may require the operator to perform a test using an intoxication detection device 212b. The intoxication detection device 212b may include a breath-based device (such as a breathalyzer), a touch-based device (such as an alcometer), or a blood-based or saliva-based test-kit.

In some embodiments, the client-side device 204 may require the operator to complete an examination questionnaire. The examination questionnaire may include questions and puzzles to assess the physical and mental fitment of the operator required to safely carryout the operation.

The processor 218 may be capable of running the client-side self-examination module 218a, the client-side video-call examination module 218b, a display and a keyboard to interact with the operator, a video camera 212a to capture the video while performing the self-examination test, an intoxication detection device 212b to measure presence of alcohol or drug, a data store, and network connectivity with the centralized server 202 via the communication network 214.

The connected asset 206 may be communicatively coupled to the centralized server 202 and the client-side device via the communication network 216. The connected asset 206 may include an instrument cluster 224, operational components 226, a memory 228, and a processor 230. The instrument cluster 224 may further include a user interface 224a to interact with an operator/administrator. The instrument cluster 224 may include, but are not limited to, a Liquid Crystal Display (LCD), a cover lens, a touch screen, a back light and other electronics components. The operational components 226 may include electronic control unit (ECU) 226a. The processor 230 may include an asset access control module 230a (same as the asset access control module 110). The asset access control module 230a may be deployed on the connected asset 206 to validate the asset operation authorization, allow the operator to access the connected asset 206, and ensure that the operation is performed as per the conditions of operation.

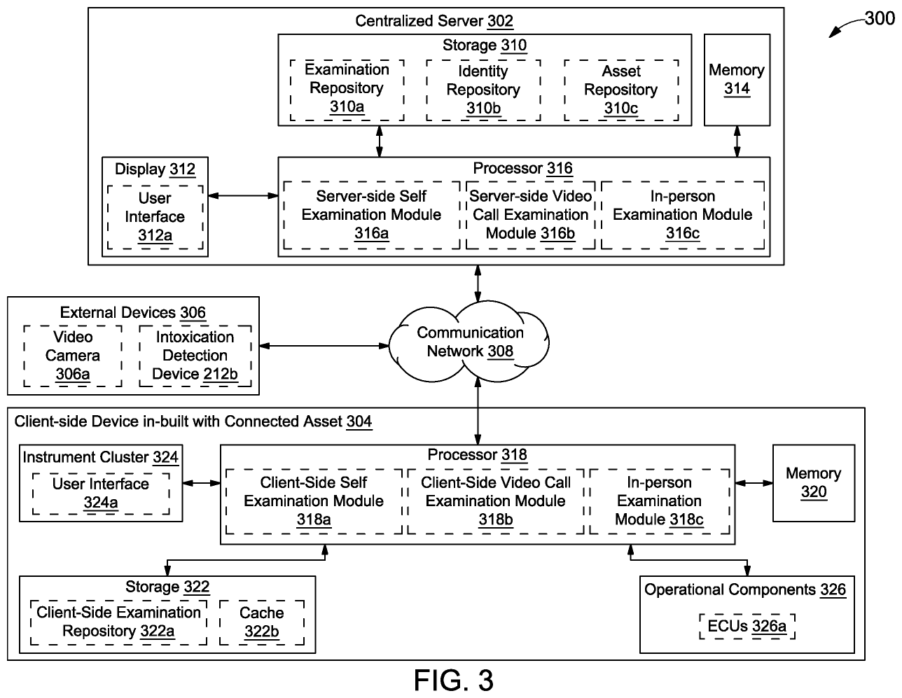

Referring now to FIG. 3, a system 300 for operator's intoxication examination and operation authorization is illustrated, in accordance with some embodiments of the present disclosure. FIG. 3 is explained in conjunction with FIGS. 1-2. The system 300 includes a centralized server 302 (same as the centralized server 202), a client-side device within a connected asset 304, external devices 306, and a communication network 308. In previous example of FIG. 2, the client-side device 204 and the connected asset are communicatively connected with each other through the communication network 214. However, in the current example, the client-side device is built within the connected asset.

The centralized server 302 may include a storage 310, a display, 312, a memory 314, and a processor 316. The storage 310 may include an examination repository 310a, an identity repository 310b, and an asset repository 310c. The display 312 may include a user interface 312a. The processor 316 may include a server-side self-examination module 316a, a server-side video-call examination module 316b, and a server-side in-person examination module 316c.

The client-side device within the connected asset 304 may include a processor 318, a memory 320, a storage 322, an instrument cluster 324, operational components 326. The processor 318 may further include a client-side self-examination module 318a, a client-side video call examination module 318b, a client side in-person examination module 318c. The storage 322 may further include a client-side examination repository 322a, and a cache 322b. The instrument cluster 324 may further include a user interface 324a. The operational components 326 may include electronic control unit (ECU) 326a It should be noted that each component or module of the centralized server 302 and client-side device built within the connected asset 304 may be analogous to the centralized server 202, the client-side device 204, and the connected asset 206.

It should be noted that the systems 100, 200, 300 may be implemented in programmable hardware devices such as programmable gate arrays, programmable array logic, programmable logic devices, or the like. Alternatively, the systems 100, 200, 300 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for feature extraction from an input image from a plurality of images in an image sensor pipeline. For example, the systems 100, 200, 300 may perform an intoxication examination of an operator for operating an asset, by the process discussed herein. In particular, as will be appreciated by those of ordinary skill in the art, control logic and/or automated routines for performing the techniques and steps described herein may be implemented by the systems 100, 200, 300 either by hardware, software, or combinations of hardware and software. For example, suitable code may be accessed and executed by the one or more processors on the systems 100, 200, 300 to perform some or all of the techniques described herein. Similarly, application specific integrated circuits (ASICs) configured to perform some or all the processes described herein may be included in the one or more processors on the systems 100, 200, 300.

The system 100, 200, 300 may help enterprises in examining an operator for intoxication and fitness level before allowing the operator to operate an equipment. The system 100, 200, 300 may begin with establishing an operator's identity. The system 100, 200, 300 may enable the operator and operators' manager to carry out an intoxication examination that also includes a questionnaire to assess fitness of the operator. The system 100, 200, 300 may provide intoxication examination methods options suitable for different workplace scenarios including self-examination, video-call-examination, and in-person-examination. The system 100, 200, 300 may work with connected assets. In that case, the system 100, 200, 300 may generate an operation authorization and send to the asset assigned to the operator. The connected asset may control the access based on the operation authorization.

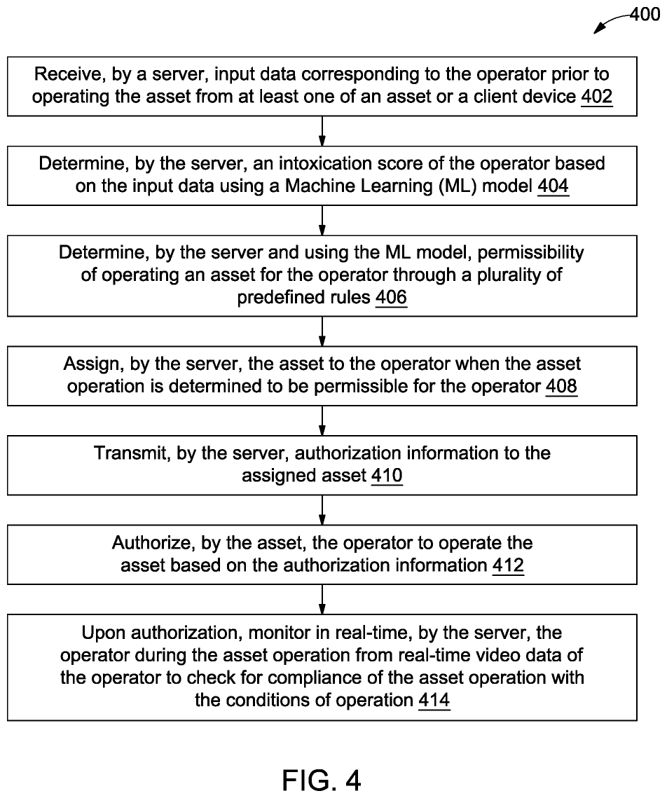

Referring now to FIG. 4, a process of intoxication examination of an operator for operating an asset is depicted via a flowchart 400, in accordance with some embodiments of the present disclosure. FIG. 4 is explained in conjunction with FIGS. 1-3.

At step 402, input data corresponding to the operator may be received by the server. The input data may be received prior to operating the asset from at least one of an asset or a client device. The input data may include an operator profile, video data of the operator, audio data corresponding to voice of the operator, and an intoxication level of the operator estimated using a plurality of intoxication examination devices. It should be noted that the asset may be in a locked state. Further, in the locked state, the asset may be inaccessible by the operator. The operator profile may include a number of past failed authorization attempts of the operator. Further, the video data of the operator may include at least one of a video recording of the operator undertaking an intoxication examination with each of the plurality of intoxication examination devices, and a video recording of the operator responding to one or more prompts via a User Interface (UI).

In some embodiments, a position and an orientation of each of the operator and an intoxication examination device may be identified with respect to video frame from the video data of the operator through the ML model. Further, in some embodiments, the operator may be notified to remain within the video frame when at least one of the operator and the intoxication examination device is out of the video frame. Additionally, in some embodiments, real-time recommendations or suggestions may be provided to the operator to continue remaining within the video frame.

It should be noted, in some embodiments, a login request from the operator prior to receiving the input data from the operator may be received by the server. The login request may be a general login request including login credential details of the operator. Further, validation of the login request may be required for further processing. Therefore, in some embodiments, the login request may be validated by the server based on the login credential details entered by the operator. In case, the login request validation is successful, a video of the operator may be recorded using a camera in real-time.

At step 404, an intoxication score of the operator may be determined by the server. The intoxication score may be determined based on the input data using a Machine Learning (ML) model. In some embodiments, an operator verification may be performed using the ML model. The operator verification may be based on a biometric identification test or an operator Identification Document (ID).

Thereafter, at step 406, a permissibility of operating an asset for the operator may be determined through a plurality of predefined rules by the server. This step may be performed using the ML model. In some embodiments, the intoxication score of the operator may be considered to check the permissibility. For example, the asset operation is permissible when the intoxication score of the operator is above a predefined threshold score required for operating the asset. In some embodiments, a plurality of responses corresponding to an examination questionnaire received from the operator may be considered for determining the permissibility. The examination questionnaire may include a plurality of questions. Further, the asset operation may be permissible when the operator correctly answers more than a predefined threshold number of questions in the questionnaire.

At step 408, the asset may be assigned by the server to the operator. The asset may be assigned when the asset operation is determined to be permissible for the operator. At step 410, authorization information may be transmitted to the assigned asset by the server. Here, the authorization information may include operator details, a class of the asset, conditions of operation, a validity period, an issuer, and checksum.

At step 412, the operator may be authorized by the asset to operate the asset based on the authorization information. Upon successful authorization, the asset may switch to an unlocked state from the locked state. It may be apparent to those skilled in the art that the unlocked state of the asset is accessible by the operator.

Thereafter, at step 414, upon authorization, the operator may be monitored by the server in real-time during the asset operation. Monitoring may be performed from real-time video data of the operator to check for compliance of the asset operation with the conditions of operation. In some embodiments, during monitoring, one or more anomalies in the asset operation may be identified. In case of identification of the one or more anomalies, a notification about the one or more anomalies may be transmitted to the operator, the administrator, and the server. Further, in some embodiments, the authorization of the operator to operate the asset may be revoked.

Additionally, in some embodiments, the input data, the real-time video data, and a number of failed authorization attempts by the operator may be stored in a historical dataset associated with the operator. Further, in some embodiments, a past behaviour record of the operator may be maintained in the operator profile based on the historical dataset associated with the operator using the ML model.

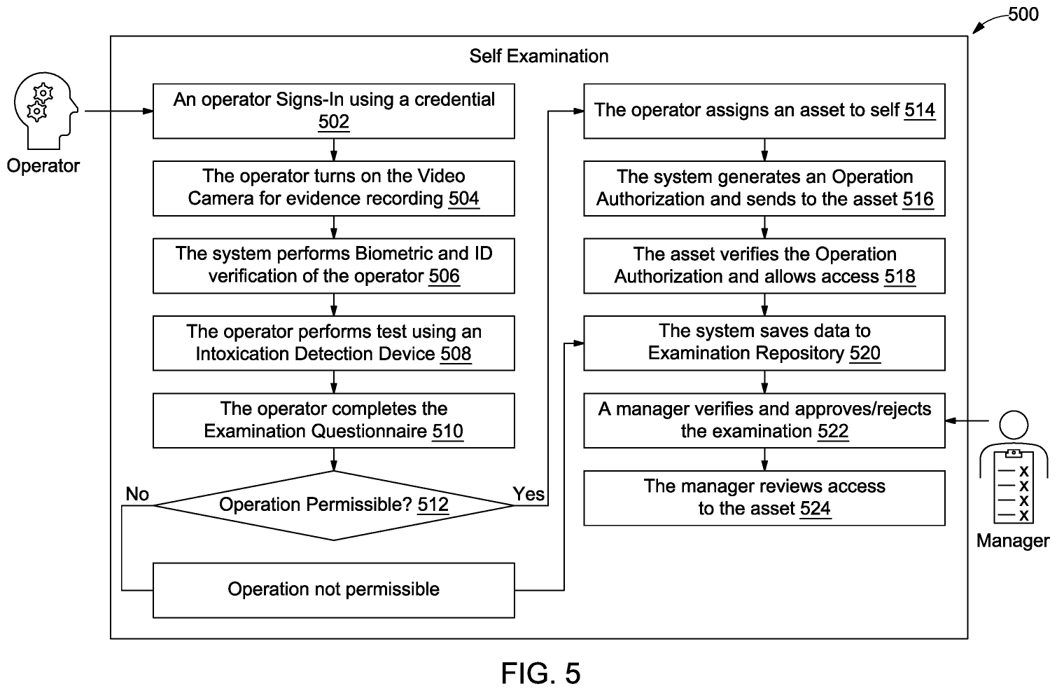

Referring now to FIG. 5, a method of operating an asset through a self-intoxication examination by the operator is depicted via a flowchart 500, in accordance with some embodiments of the present disclosure. FIG. 5 is explained in conjunction with FIGS. 1-4.

At step 502, an operator may send a sign in request (login request) to a server (for example, the centralized server 202) associated with the system. The sign in request may include credentials (such as login credentials). The operator may sign in using these credentials. If sign in details or credentials provided by the operator are correct or successfully validated by the server then the intoxication examination may get initiated. For example, in FIG. 5 a self-examination is explained, where the operator may perform the intoxication examination.

At step 504, the operator may turn on a camera. A video of evidence may be recorded using the camera. This video of evidence may be used further to check intoxication level of the operator. At step 506, operator verification may be performed based on a biometric identification test or an operator Identification Document (ID). A Machine Learning (ML) model may be used to perform the operator Identification.

At step 508, the operator may perform an intoxication test using one or more intoxication examination devices. The one or more intoxication examination devices may be used to estimate the intoxication level of the operator. In some embodiments, the operator may have to respond to a plurality of questions provided in an examination questionnaire, at step 510. Thereafter, at step 512, a condition of operation permissibility may be checked. In other words, permissibility of operating the asset for the operator may be determined. The ML model may be used to check the permissibility. In some embodiments, the ML model may be an ensemble model. Further, examples of the ML model may include, but are not limited to a supervised learning ML model, an unsupervised learning ML model, a regression type ML model, a classification type ML model, a random forest ML model, a Neural Network (NN) model or the like.

In one embodiment, the permissibility may be checked based on an intoxication score determined by the ML model which may be determined based on the video recording, the user details, a user profile, and the intoxication test. For example, when the intoxication score of the operator is above a predefined threshold score required for operating the asset, the asset operation is permissible. In some other embodiments, the permissibility may be checked based on a plurality of responses corresponding to an examination questionnaire received from the operator. For example, when the operator correctly answers more than a predefined threshold number of questions in the questionnaire, the asset operation is permissible.

At step 514, the operator may assign the asset to self when the permissibility condition is true, or the asset operation is permissible. At step 516, the server generates a signal of asset authorization. The signal may be transmitted to the assigned asset. At step 518, the asset may verify the operation authorization and upon successful authorization allows the operator to access the asset.

Further, in case the asset operation is not permissible, failed authorization attempts by the operator may be stored in a historical dataset (examination repository) associated with the operator, at step 520. Further, at step 520, upon successful verification of the operation authorization corresponding data may be saved to the examination repository.

At step 522, a manager/administrator may verify the intoxication examination performed by the operator. At step 524, manager/administrator may review the access of operator to the asset. The manager/administrator may use data save in the examination repository. The examination repository may include, but not limited to, the real-time video data, intoxication examination results, operator's information, video recordings, intermediate results generated while performing various steps, and a number of failed authorization attempts by the operator in a historical dataset associated with the operator.

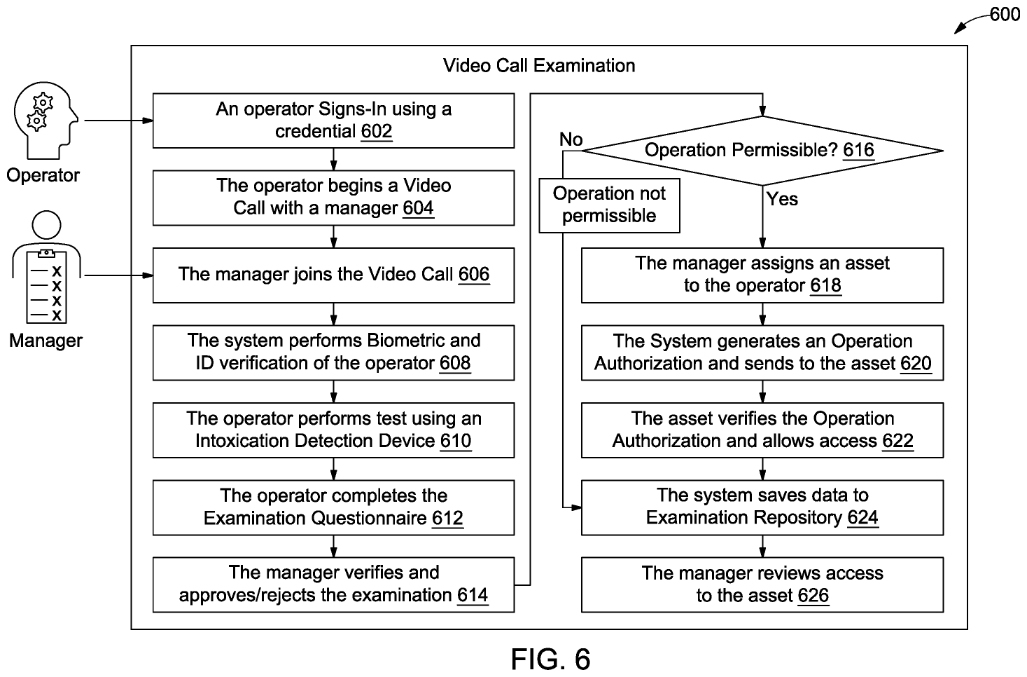

Referring now to FIG. 6, a method of operating an asset through a video call-based intoxication examination is depicted via a flowchart 600, in accordance with some embodiments of the present disclosure. FIG. 6 is explained in conjunction with FIGS. 1-5.

At step 602, an operator may sign-in using login credentials. In case, sign-in details or credentials provided by the operator are correct or successfully validated by a server (for example the centralized server 202, 302) then the operator may connect with the system for further processing. By way of an example, in FIG. 6 a video-call examination with the manager/administrator is explained, where the operator may video call the manager/administrator through a video camera.

At step 604, the operator may turn on the video camera to start a video call with the manager/administrator. However, in the self-examination video camera may be used only to record a video of evidence. In the current example, the video camera may be used for both the purpose (i.e., for initiating the video call and recording the video of evidence). Further, a manager/administrator may accept or reject the video call. The manger/administrator may join the call, at step 606.

At step 608, an operator verification may be performed through a biometric identification test and/or an Identity Document (ID) verification. The biometric identification test may include, but is not limited to facial recognition, fingerprint matching, voice recognition, retina scanning, and the like. In some embodiments, the operator may be allowed to use a valid ID proof issued by an employer (such as, an employee ID card), and a valid ID proof issued by a government agency (such as a driving license). In some embodiments, an Optical Character Recognition (OCR) technique, a barcode, and a QR Code may be used for ID verification.

At step 610, an intoxication detection test may be performed by the operator through an intoxication detection device (same as the intoxication detection device 212b). The intoxication detection test may be performed to measure presence of alcohol or drug. The intoxication detection device may include a breath-based device (such as a breathalyzer), a touch-based device (such as an alcometer), or a blood-based or saliva-based test-kit.

At step 612, the operator may response to a plurality of questions provided in an examination questionnaire. The examination questionnaire may include questions and puzzles to review the physical and mental fitment of the operator required to securely perform the operation of the asset. At step 614, the manager/administrator may verify the intoxication examination based on the intoxication test and the responses to the examination questionnaire. Further, the manager/administrator may approve/reject the intoxication examination.

At step 616, it may be checked if the operation is permissible. In other words, permissibility of operating the asset for the operator may be determined. A Machine Learning (ML) may be used to check the permissibility. In some embodiments, the ML model may be an ensemble model. Further, examples of the ML model may include, but are not limited to, a supervised learning ML model, an unsupervised learning ML model, a regression type ML model, a classification type ML model, a random forest ML model, a Neural Network (NN) model or the like.

In one embodiment, the permissibility may be checked based on an intoxication score determined by the ML model which may be determined based on the video recording, the user details, a user profile, and the intoxication test. For example, when the intoxication score of the operator is above a predefined threshold score required for operating the asset, the asset operation is permissible. In some other embodiments, the permissibility may be checked based on a plurality of responses corresponding to an examination questionnaire received from the operator. For example, when the operator correctly answers more than a predefined threshold number of questions in the questionnaire, the asset operation is permissible.

At step 618, the manager may assign the asset to the operator if the operation is permissible. At step 620, an operation authorization may be generated by the server. Further, a signal corresponding to the operation authorization may be sent to the asset. The asset may further verify the operation authorization and based on verification allow the access to the operator, at step 622.

Further, at step 624, data may be stored in an examination repository (such as, the examination repository 210a). The examination repository may be used to store data including a recording of the video-call intoxication examination, measurements from the intoxication detection device, answers to the examination questionnaire, decision taken by the system based on business rules, and approval information by the manager. At step 626, the manager/administrator may review the access of the operator to the asset.

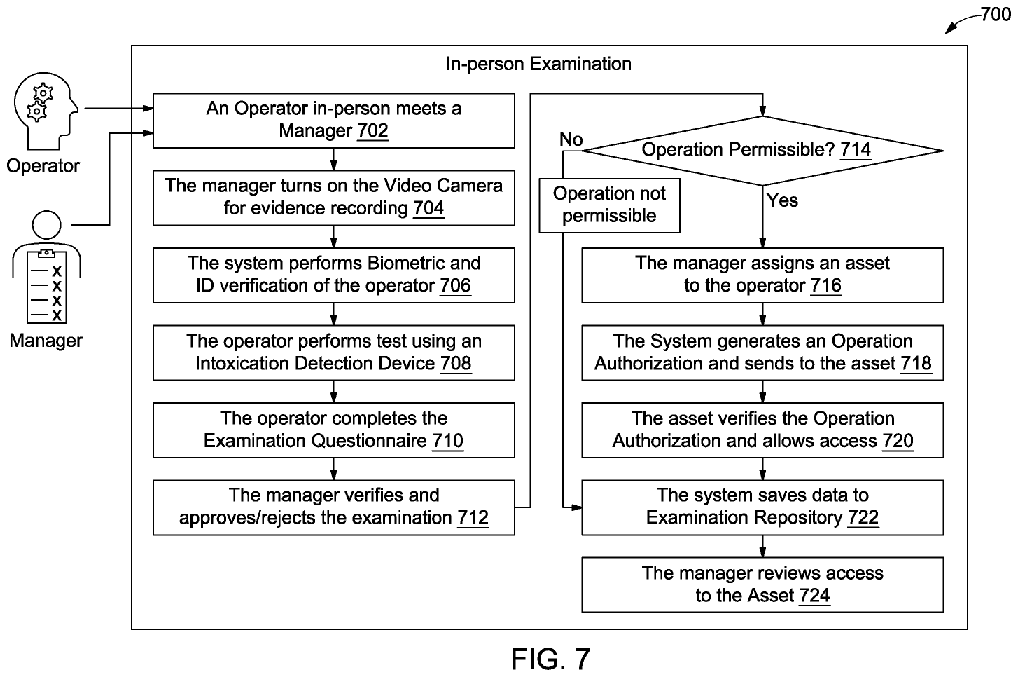

Referring now to FIG. 7, a method of method operating an asset through an in-person intoxication examination via a flowchart 700, in accordance with some embodiments of the present disclosure. FIG. 7 is explained in conjunction with FIGS. 1-6.

At step 702, an operator may in-person meet a manager/administrator. At step 704, the manager/administrator may turn on a video camera to check a video of evidence. The video of evidence may be recorded using the video camera by the operator. This video of evidence may be used to check intoxication level of the operator.

At step 706, an operator verification may be performed through a biometric identification test and/or an Identity Document (ID) verification. The biometric identification test may include, but is not limited to facial recognition, fingerprint matching, voice recognition, retina scanning, and the like. In some embodiments, the operator may be allowed to use a valid ID proof issued by an employer (such as, an employee ID card), and a valid ID proof issued by a government agency (such as a driving license). In some embodiments, an Optical Character Recognition (OCR) technique, a barcode, and a QR Code may be used for ID verification.

At step 708, an intoxication detection test may be performed by the operator through an intoxication detection device (same as the intoxication detection device 212b). The intoxication detection test may be performed to measure presence of alcohol or drug. The intoxication detection device may include a breath-based device (such as a breathalyzer), a touch-based device (such as an alcometer), or a blood-based or saliva-based test-kit.

At step 710, the operator may response to a plurality of questions provided in an examination questionnaire. The examination questionnaire may include questions and puzzles to review the physical and mental fitment of the operator required to securely perform the operation of the asset. At step 712, the manager/administrator may verify the intoxication examination based on the intoxication test and the responses to the examination questionnaire. Further, the manager/administrator may approve/reject the intoxication examination.

At step 714, it may be checked if the operation is permissible. In other words, permissibility of operating the asset for the operator may be determined. A Machine Learning (ML) model may be used to check the permissibility. In some embodiments, the ML model may be an ensemble model. Further, examples of the ML model may include, but are not limited to, a supervised learning ML model, an unsupervised learning ML model, a regression type ML model, a classification type ML model, a random forest ML model, a Neural Network (NN) model or the like.

In one embodiment, the permissibility may be checked based on an intoxication score determined by the ML model which may be determined based on the video recording, the user details, a user profile, and the intoxication test. For example, when the intoxication score of the operator is above a predefined threshold score required for operating the asset, the asset operation is permissible. In some other embodiments, the permissibility may be checked based on a plurality of responses corresponding to an examination questionnaire received from the operator. For example, when the operator correctly answers more than a predefined threshold number of questions in the questionnaire, the asset operation is permissible.

At step 716, the manager may assign the asset to the operator if the operation is permissible. At step 718, an operation authorization may be generated by the server. Further, a signal corresponding to the operation authorization may be sent to the asset. The asset may further verify the operation authorization and based on verification allow the access to the operator, at step 720.

Further, at step 722, data may be stored in an examination repository (such as, the examination repository 210a). The examination repository may be used to store data including a recording of the video-call intoxication examination, measurements from the intoxication detection device, answers to the examination questionnaire, decision taken by the system based on business rules, and approval information by the manager. At step 724, the manager/administrator may review the access of the operator to the asset.

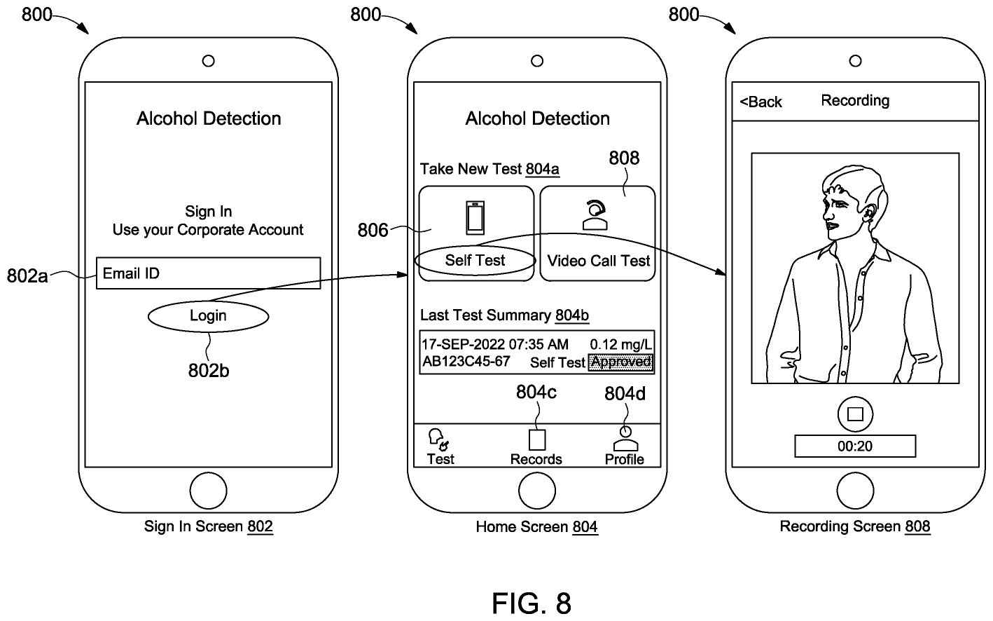

Referring now to FIG. 8, a client-side device 800 representing alcohol detection through a self-examination test is illustrated, in accordance with some embodiments of the present disclosure. It should be noted that a client-side device 800 may include, but is not limited to, a smartphone, a laptop, a computer; any device integrated with the asset, a Digital Instrument Cluster (DIC) or the like. In the present example, the client-side device 800 is a mobile phone of the operator. FIG. 8 is explained in conjunction with FIGS. 1-7.

In some embodiments, the client-side device 800 may include a sign-in screen 802. The sign-in screen 802 may further include a section 802a to populate an email address. Also, the sign-in screen 802 may have a login tab 802b. The operator may enter corresponding email address to the section 802a. Thereafter, the operator needs to press the login tab 802b for submission. There may be other sections to provide login credentials which may be reflected on the sign-in screen 802 after submitting the email address. For example, in some embodiments, the operator needs to submit a corresponding password.

Further, if the login credentials entered by the operator are correct, a home screen 804 may be reflected on the client-side device 800. The home screen 804 may include an option of take new test 804a, last test summary 804b, records 804c, and a user profile section 804d. The option of take new test 804a may have a self-test option 806 and a video-call option 808. In the present example, the operator may select the self-test 806.

Further, in some embodiments, the client-side device 800 may include the recording screen 808 which shows recording of a real-time video of the operator during performing the self-test of intoxication examination.

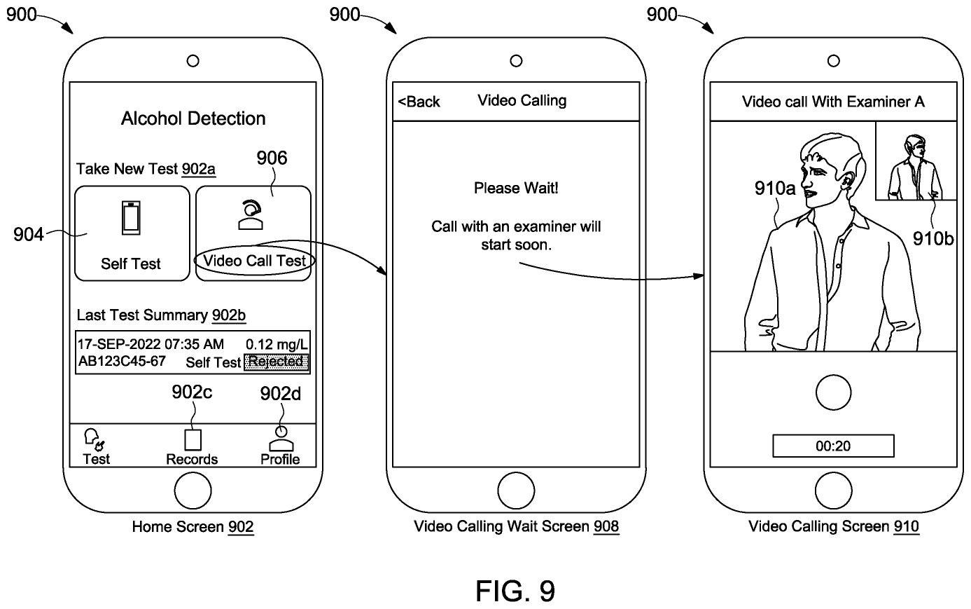

Referring now to FIG. 9, a client-side device 900 representing alcohol detection through a video-call examination with a manager/administrator is illustrated, in accordance with some embodiments of the present disclosure. It should be noted that a client-side device 900 may include, but is not limited to, a smartphone, a laptop, a computer; any device integrated with the asset, a Digital Instrument Cluster (DIC) or the like. In the present example, the client-side device 900 is a mobile phone of the operator. FIG. 9 is explained in conjunction with FIGS. 1-8.

If the login credentials entered by the operator are correct, a home screen 902 may be reflected on the client-side device 900. The home screen 902 may include an option of take new test 902a, last test summary 902b, records 902c, and a user profile section 902d. The option of take new test 902a may have a self-test option 904 and a video-call option 906. In the present example, the operator may select the video-call option 906.

After selecting the video call option 906, a video calling wait screen 908 may appear in front of the operator. As illustrated in FIG. 9, in starting, the video calling wait screen 908 may show “Please wait! Video call with examiner will start soon”. Therefore, the operator may have to wait for a sometime for the examiner (manager/administrator) to reject/accept the video call. In the video call examination, the examiner may join the call. The waiting time may depend on the examiner and the system processing.

Further, the client-side device may include a video calling screen 910. The video calling screen appears in front of the operator just after the call joining by the examiner. The video calling screen 910 represents the operator 910a and the examiner 910b.

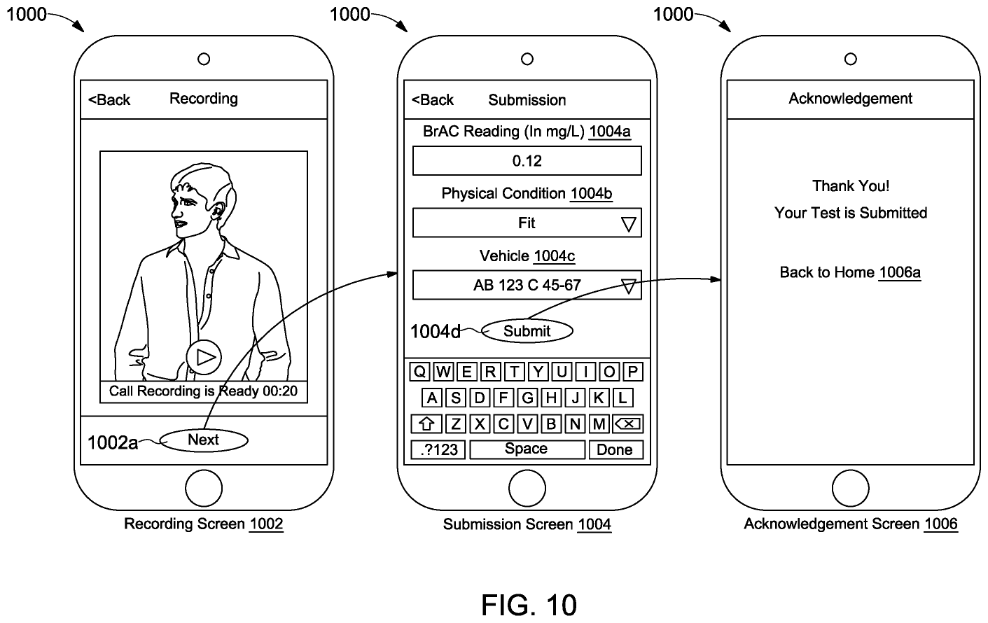

Referring now to FIG. 10, a client-side device 1000 representing submission of recoding of evidence video captured while performing a self-examination test or the video call examination is illustrated, in accordance with some embodiments of the present disclosure. It should be noted that a client-side device may include, but is not limited to, a smartphone, a laptop, a computer; any device integrated with the asset, a Digital Instrument Cluster (DIC) or the like. In the present example, the client-side device 1000 is a mobile phone of the operator. FIG. 10 is explained in conjunction with FIGS. 1-9.

In some embodiments, the client-side device 1000 may include a recording screen 1002. In some embodiments, the client-side device 1000 may include a submission screen 1004. In some embodiments, the client-side device 1000 may include an acknowledgement screen 1006. The recording screen 1002 may represent at least one of a recording of a self-examination test by the operator, a recording of a video-call examination test. The recording screen 1002 may also include a next tab 1002a through which the operator may access the submission screen 1004.

Further, the submission screen 1004 may include a Breath Alcohol Content (BrAc) reading 1004a. For example, for a particular test BrAc reading of the operator may be ‘0.12’. The submission screen 1004 may include a physical condition section 1004b. For example, the physical condition of the operator for the current example is ‘Fit’. The submission screen 1004 may further include a section of vehicle number 1004c (for example, AB 123 C45-67). Further, the submission screen 1004 may include a submit button 1004d to submit all the details of the intoxication examination.

The acknowledgement screen 1006 may appear after pressing the submit button 1004d. The acknowledgement screen 1006 may represent a message of acknowledgement “Thank You! Your test is submitted”. Further the acknowledgement screen 1006 may also have an option of going back to home screen 1006a.

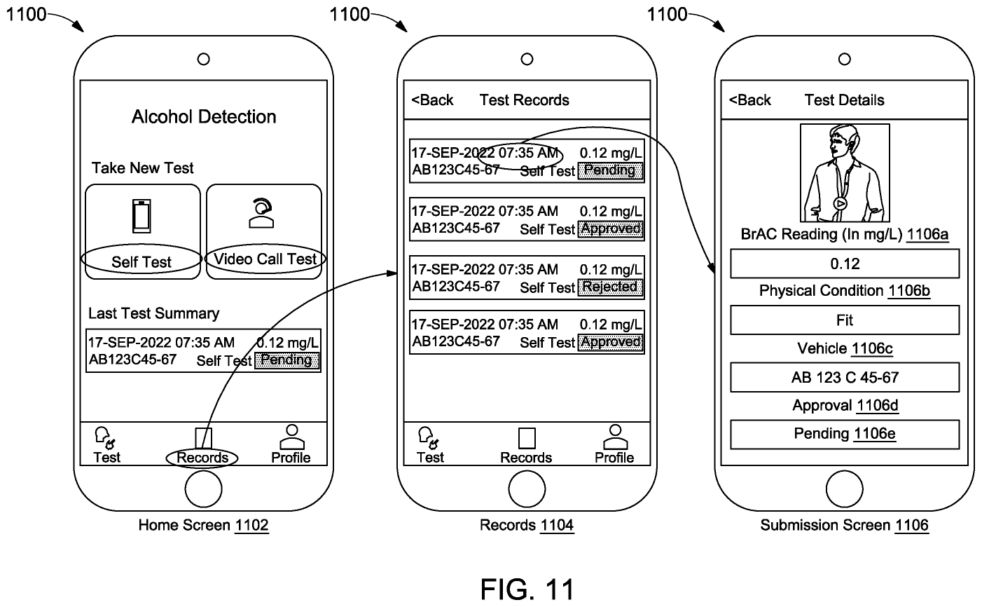

Referring now to FIG. 11, a client-side device 1100 representing submission of a test record from a plurality of test records is illustrated, in accordance with some embodiments of the present disclosure. It should be noted that a client-side device 1100 may include, but is not limited to, a smartphone, a laptop, a computer; any device integrated with the asset, a Digital Instrument Cluster (DIC) or the like. In the present example, the client-side device 1100 is a mobile phone of the operator. FIG. 11 is explained in conjunction with FIGS. 1-10.

In some embodiments, the client-side device 1100 may include a home screen 1102. In some embodiments, the client-side device 1100 may include different test records 1104. In some embodiments, the client-side device 1100 may include a submission screen 1106. The home screen 1102 may be similar to the home screen 804 and have components similar to the components of the home screen 804. When the operator presses the records tab of the home screen 1102, different records may get opened and test details corresponding to a latest record may appear on the submission screen 1106.

The submission screen 1106 may a Breath Alcohol Content (BrAc) reading 1106a. For example, for a particular test BrAc reading of the operator may be ‘0.12’. The submission screen 1106 may include a physical condition section 1106b.

For example, the physical condition of the operator for the current example is ‘Fit’. The submission screen 1106 may further include a section of vehicle number 1106c (for example, AB 123 C45-67). Moreover, the submission screen 1106 may include an approval 1106d and a pending option 1106e.

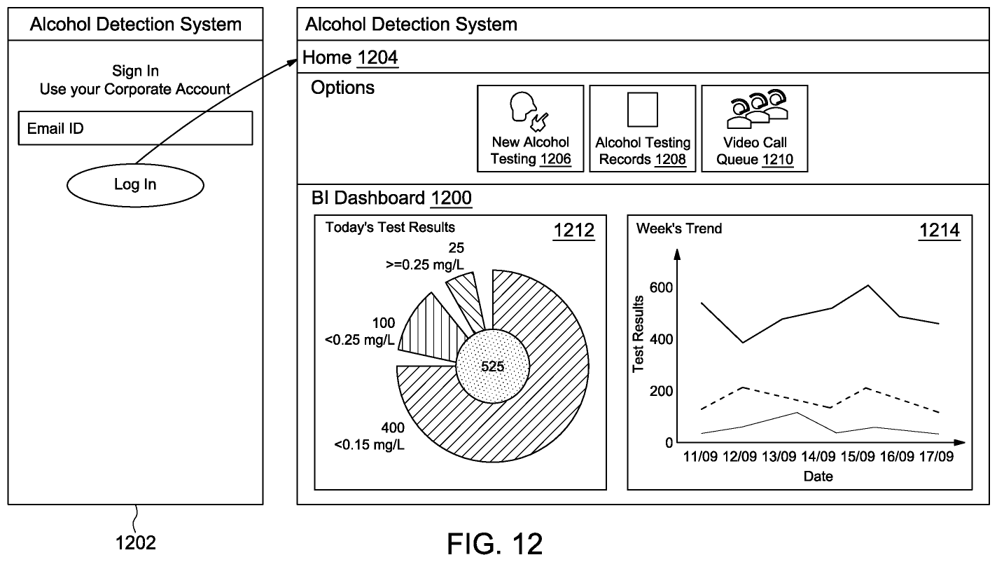

Referring now to FIG. 12, a Business Intelligence (BI) dashboard 1200 corresponding to an exemplary alcohol detection system is illustrated, in accordance with some embodiments of the present disclosure. FIG. 12 is explained in conjunction with FIGS. 1-11. The alcohol detection system and associated client device may include a sign-in screen 1202. The sign-in screen may have components similar to the sign-in screen 802. Further, after logging in, a home screen 1204 may appear on the client-side device. And, a plurality of test options such as new alcohol testing 1206, alcohol testing records 1208, and video call queue 1210 may be reflected on the home screen 1204.

Further, the BI dashboard may represent intoxication examination test results via a data chart 1212 of test results of present day and a graphical representation 1214. Vertical axis of the graphical representation represents weekly trends of test results and horizontal axis represents dates corresponding to the weekly trends of test results.

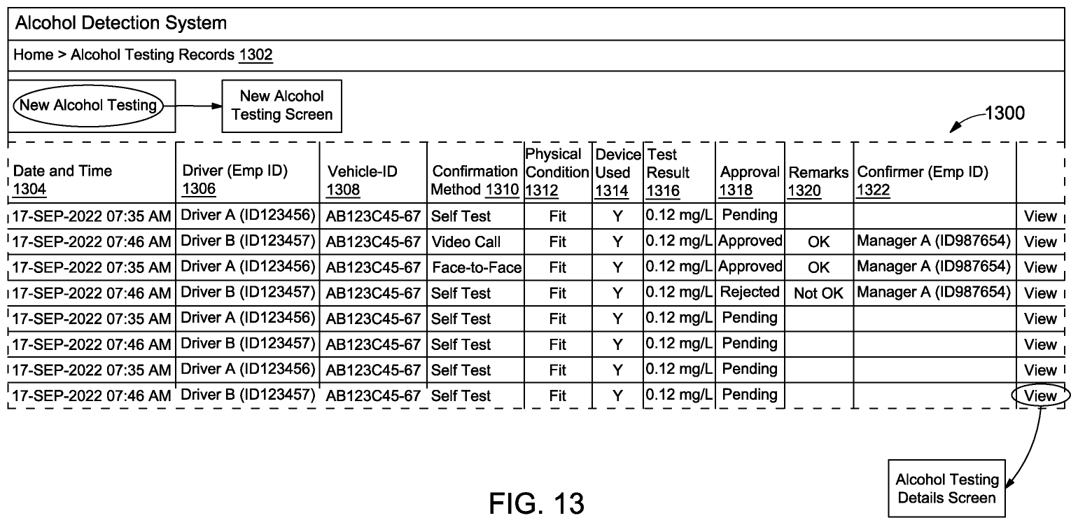

Referring now to FIG. 13, a table 1300 representing details of various alcohol testing records 1302 is illustrated, in accordance with some embodiments of the present disclosure. FIG. 13 is explained in conjunction with FIGS. 1-12. The table 1300 may include various columns including a date and time 1304, a driver (Emp Id) 1306 (for example, a driver A (ID 123456) and a driver B (ID 123457)), a vehicle ID 1308 (for example, AB 123C45-67), a confirmation method 1310 (for example, a self-examination test, a video call test, and a face to face test), a physical condition 1312 (for example, fit condition), a device used 1314, a test result 1316 (for example, 0.12 mg/L), an approval status 1318 (for example, approved, rejected, and pending), remarks 1320 (for example, ok or not), confirmer (Emp ID) 1322 (for example, a manger (ID 987654).

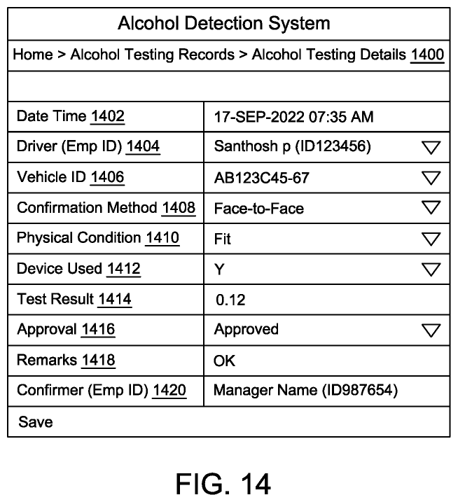

As illustrated in FIG. 13, each alcohol test may be performed on a date 17 Sep. 2022 and at different time. For example, alcohol tests may be performed at 07.35 AM and at 07.46 AM. Further, each record may be opened by clicking on a corresponding view tab. This is further explained in conjunction with FIG. 14.

Referring now to FIG. 14, details of an exemplary alcohol testing record 1400 are illustrated, in accordance with some embodiments of the present disclosure. FIG. 14 is explained in conjunction with FIG. 13. When an operator clicks on a view tab corresponding to an alcohol testing record of the alcohol testing records 1302, corresponding alcohol testing details may be visible. For example, the operator may click on the view tab of a third alcohol testing result of the alcohol testing records 1302. As a result, the details as shown in FIG. 14 may be visible to the operator. The details may include date and time 1402 (i.e., 17 Sep. 2022, and 07.35 AM), a driver (Emp Id) 1404 (for example, Santosh P (ID 123456)), a vehicle ID 1406 (for example, AB 123C45-67), a confirmation method 1408 (for example, a face to face test), a physical condition 1410 (for example, a fit condition), a device used 1412, a test result 1414 (for example, 0.12 mg/L), an approval status 1416 (for example, approved), remarks 1418 (for example, ok), confirmer (Emp ID), 1420 (for example, a manger (ID 987654).

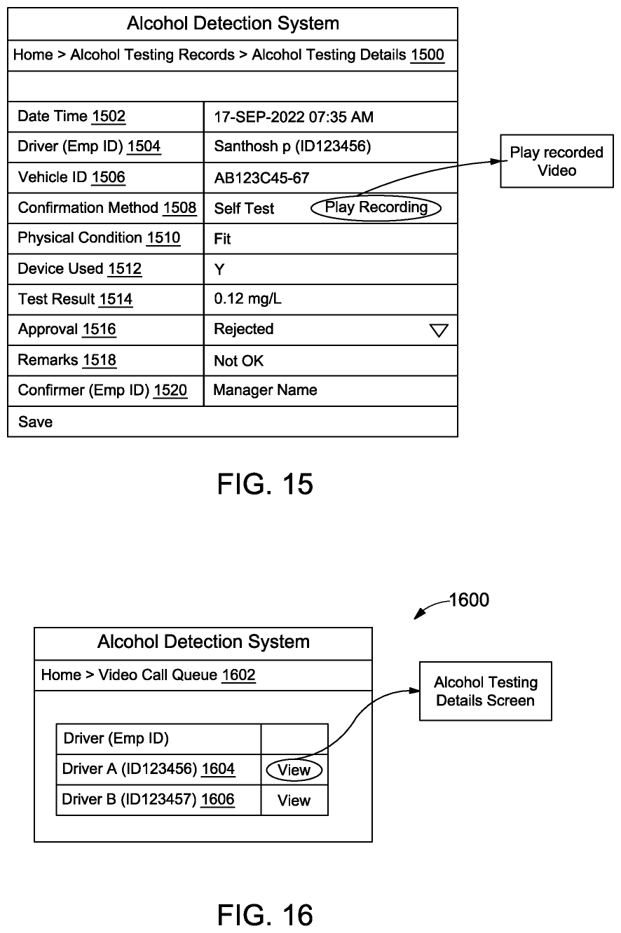

Referring now to FIG. 15, details of another exemplary alcohol testing record 1500 are illustrated, in accordance with some embodiments of the present disclosure. FIG. 15 is explained in conjunction with FIG. 13. When an operator clicks on a view tab corresponding to an alcohol testing record of the alcohol testing records 1302, corresponding alcohol testing details may be visible. For example, the operator may click on the view tab of a fifth alcohol testing result of the alcohol testing records 1302. As a result, the details as shown in FIG. 15 may be visible to the operator. The details may include date and time 1502 (i.e., 17 Sep. 2022, and 07.46 AM), a driver (Emp Id) 1504 (for example, Santosh P (ID 123456)), a vehicle ID 1506 (for example, AB 123C45-67), a confirmation method 1508 (for example, a self-test), a physical condition 1510 (for example, a fit condition), a device used 1512, a test result 1514 (for example, 0.12 mg/L), an approval status 1516 (for example, rejected), remarks 1518 (for example, Not ok), confirmer (Emp ID), 1520 (for example, a manger (ID 987654).

Referring now to FIG. 16, a video call queue 1602 on a home screen 1600 of an exemplary client-side device (such as the client-side device 204) is illustrated, in accordance with some embodiments of the present disclosure. FIG. 16 is explained in conjunction with FIGS. 1-15. The video call queue 1602 may include a plurality of video call request from different drivers. For example, video calls from a driver A 1602 (ID 123456) and a driver B 1604 (ID 123457). Further, the video call queue 1602 may also include a view tab corresponding to each of the drivers used to check corresponding alcohol testing details.

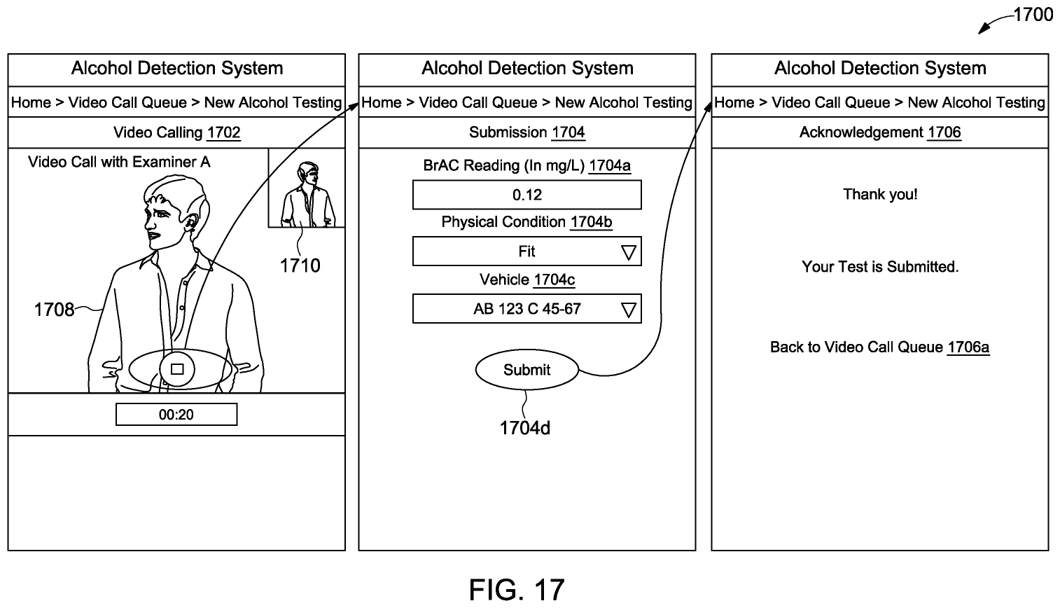

Referring now to FIG. 17, an exemplary client-side device 1700 representing submission of video recording captured while performing a video-call examination test is illustrated, in accordance with some embodiments of the present disclosure. FIG. 17 is explained in conjunction with FIGS. 1-16. It should be noted that a client-side device may include, but is not limited to, a smartphone, a laptop, a computer; any device integrated with the asset, a Digital Instrument Cluster (DIC) or the like. In the present example, the client-side device 1700 is a mobile phone of an operator.

In some embodiments, the client-side device 1700 may include a video calling screen 1702. In some embodiments, the client-side device 1700 may include a submission screen 1704. In some embodiments, the client-side device 1700 may include an acknowledgement screen 1706. The video calling screen 1702 may represent a recording of a video-call examination test. The video calling screen 1702 may represent video calling of an operator 1708 with an examiner 1710.

Further, the submission screen 1704 may include a Breath Alcohol Content (BrAc) reading 1704a. For example, for a particular test BrAc reading of the operator may be ‘0.12 mg/L’. The submission screen 1704 may include a physical condition section 1704b. For example, the physical condition of the operator for the current example is ‘Fit’. The submission screen 1704 may further include a section of vehicle number 1704c (for example, AB 123 C45-67). Further, the submission screen 1704 may include a submit button 1704d to submit all the details of the intoxication examination.

The acknowledgement screen 1706 may appear after pressing the submit button 1704d. The acknowledgement screen 1706 may represent a message of acknowledgement “Thank You! Your test is submitted”. Further the acknowledgement screen 1706 may also have an option of going back to home screen 1706a.

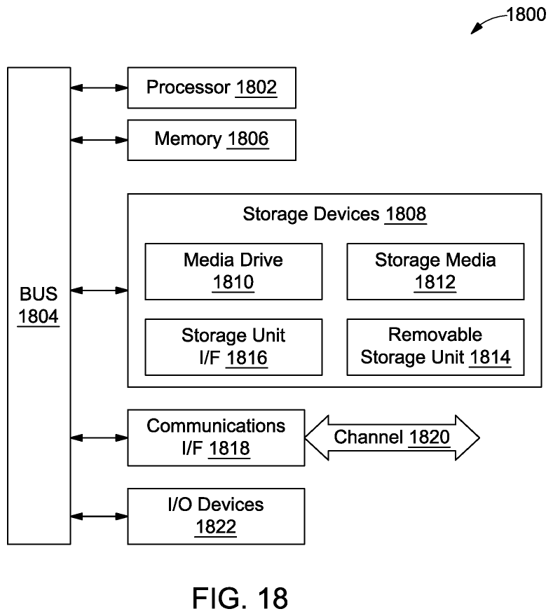

The disclosed methods and systems may be implemented on a conventional or a general-purpose computer system, such as a personal computer (PC) or server computer. Referring now to FIG. 18, an exemplary computing system 1800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1800 may represent, for example, a user device such as a desktop, a laptop, a mobile phone, personal entertainment device, DVR, and so on, or any other type of special or general-purpose computing device as may be desirable or appropriate for a given application or environment. The computing system 1800 may include one or more processors, such as a processor 1802 that may be implemented using a general or special purpose processing engine such as, for example, a microprocessor, microcontroller or other control logic. In this example, the processor 802 is connected to a bus 1802 or other communication medium. In some embodiments, the processor 1802 may be an AI processor, which may be implemented as a Tensor Processing Unit (TPU), or a graphical processor unit, or a custom programmable solution Field-Programmable Gate Array (FPGA).

The computing system 1800 may also include a memory 1806 (main memory), for example, Random Access Memory (RAM) or other dynamic memory, for storing information and instructions to be executed by the processor 1802. The memory 1806 also may be used for storing temporary variables or other intermediate information during execution of instructions to be executed by the processor 1802. The computing system 1800 may likewise include a read only memory (“ROM”) or other static storage device coupled to bus 1804 for storing static information and instructions for the processor 1802.

The computing system 1800 may also include a storage device 1808, which may include, for example, a media drives 1810 and a removable storage interface. The media drive 1810 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 1812 may include, for example, a hard disk, magnetic tape, flash drive, or other fixed or removable medium that is read by and written to by the media drive 1810. As these examples illustrate, the storage media 1812 may include a computer-readable storage medium having stored there in particular computer software or data.

In alternative embodiments, the storage devices 1808 may include other similar instrumentalities for allowing computer programs or other instructions or data to be loaded into the computing system 1800. Such instrumentalities may include, for example, a removable storage unit 1814 and a storage unit interface 1816, such as a program cartridge and cartridge interface, a removable memory (for example, a flash memory or other removable memory module) and memory slot, and other removable storage units and interfaces that allow software and data to be transferred from the removable storage unit 1814 to the computing system 1800.

The computing system 1800 may also include a communications interface 1818. The communications interface 1818 may be used to allow software and data to be transferred between the computing system 1800 and external devices. Examples of the communications interface 1818 may include a network interface (such as an Ethernet or other NIC card), a communications port (such as for example, a USB port, a micro USB port), Near field Communication (NFC), etc. Software and data transferred via the communications interface 1818 are in the form of signals which may be electronic, electromagnetic, optical, or other signals capable of being received by the communications interface 1818. These signals are provided to the communications interface 1818 via a channel 1820. The channel 1820 may carry signals and may be implemented using a wireless medium, wire or cable, fiber optics, or other communications medium. Some examples of the channel 1820 may include a phone line, a cellular phone link, an RF link, a Bluetooth link, a network interface, a local or wide area network, and other communications channels.

The computing system 1800 may further include Input/Output (I/O) devices 1822. Examples may include, but are not limited to a display, keypad, microphone, audio speakers, vibrating motor, LED lights, etc. The I/O devices 1822 may receive input from a user and also display an output of the computation performed by the processor 1802. In this document, the terms “computer program product” and “computer-readable medium” may be used generally to refer to media such as, for example, the memory 1812, the storage devices 1808, the removable storage unit 1814, or signal(s) on the channel 1820. These and other forms of computer-readable media may be involved in providing one or more sequences of one or more instructions to the processor 1802 for execution. Such instructions, generally referred to as “computer program code” (which may be grouped in the form of computer programs or other groupings), when executed, enable the computing system 1800 to perform features or functions of embodiments of the present invention.

In an embodiment where the elements are implemented using software, the software may be stored in a computer-readable medium and loaded into the computing system 1800 using, for example, the removable storage unit 1814, the media drive 1810 or the communications interface 1818. The control logic (in this example, software instructions or computer program code), when executed by the processor 1802, causes the processor 1802 to perform the functions of the invention as described herein.

Thus, the present disclosure may overcome drawbacks of traditional systems discussed before. The present disclosure may enable the enterprises to implement a system for proactive screening of employees for alcohol and drug abuse (ADA) before they are allowed to perform a job. Further, the business establishment across the industry segments may benefit with implementation of Driving Under the Influence (DUI) prevention and Drug-Free Workplace (DFW) programs. The industry segment may include transport and logistics companies, railways, airlines, air traffic operations, defense establishments, police and security forces, nuclear operations, shipyard industry, maritime industry, oil refineries, mining industry, construction industry, warehouse, manufacturing industry, and the like. The present disclosure provides an intoxication examination method that may alternatively suites to different workplace scenarios. For example, the self-examination may be suitable for scenarios where an operator is required to work from remote locations, but a manager may be unavailable physically or virtually. In such scenarios, the operator may be allowed to perform the self-examination for intoxications and fitness levels, and then the operator needs to follow decisions of the system based on permissibility of the operation. By way of another example, the video-call examination method may be suitable for the scenarios where the operator is required to work from remote locations often and may connect with a manager virtually over a video call. In such scenarios, the operator may be allowed to have a video call with the manager while intoxications and fitness examination is carried out. Further, the in-person examination method may be suitable for the scenarios where the operator is required to visit a location and meet in-person with the manager. In such scenarios, the operator may be required to take intoxications and fitness examination directly and physical supervision of the manager.

Further, the disclosure may enable the enterprises to use a wide range of choices from various options for biometric identification and ID verifications. The biometric identification may include a facial recognition, a fingerprint matching, a voice recognition, a retina scan, and the like. The ID verification may include an Optical Character Recognition (OCR) technique, a Barcode technique, and a QR Code technique. Further, the disclosure enables assigning an asset to the operator after qualifying intoxication examination. The operation authorization and the asset access control may enable the asset to implement access control based on conditions of operations for the operator.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of intoxication examination of an operator for operating an asset, the method comprising:
receiving, by a server, input data corresponding to the operator prior to operating the asset from at least one of an asset or a client device, wherein the asset is in a locked state, and wherein in the locked state the asset is inaccessible by the operator;
determining, by the server, an intoxication score of the operator based on the input data using a Machine Learning (ML) model;
determining, by the server and using the ML model, permissibility of operating an asset for the operator through a plurality of predefined rules based on:
the intoxication score of the operator, wherein the asset operation is permissible when the intoxication score of the operator is above a predefined threshold score required for operating the asset; and
a plurality of responses corresponding to an examination questionnaire received from the operator, wherein the examination questionnaire comprises a plurality of questions, and wherein the asset operation is permissible when the operator correctly answers more than a predefined threshold number of questions in the questionnaire;
assigning, by the server, the asset to the operator when the asset operation is determined to be permissible for the operator;
transmitting, by the server, authorization information to the assigned asset, wherein the authorization information comprises operator details, a class of the asset, conditions of operation, a validity period, an issuer, and checksum;
authorizing, by the asset, the operator to operate the asset based on the authorization information, wherein upon successfully authorizing, the asset is in an unlocked state, and wherein in the unlocked state the asset is accessible by the operator; and
upon authorization, monitoring in real-time, by the server, the operator during the asset operation from real-time video data of the operator to check for compliance of the asset operation with the conditions of operation.

2. The method of claim 1, wherein:
the input data comprises operator profile, video data of the operator, audio data corresponding to voice of the operator, and intoxication level of the operator estimated using a plurality of intoxication examination devices,
the operator profile comprises number of past failed authorization attempts of the operator, and
the video data of the operator comprises at least one of:
a video recording of the operator undertaking an intoxication examination with each of the plurality of intoxication examination devices, and
a video recording of the operator responding to one or more prompts via a User Interface (UI).

3. The method of claim 2, further comprising:
identifying a position and an orientation of each of the operator and an intoxication examination device with respect to video frame from the video data of the operator through the ML model;
notifying the operator to remain within the video frame when at least one of the operator and the intoxication examination device is out of the video frame; and
providing real-time recommendations to the operator to continue remaining within the video frame.

4. The method of claim 1, wherein monitoring in real-time, the operator comprises:
identifying one or more anomalies in the asset operation; and
upon identification of the one or more anomalies, transmitting a notification about the one or more anomalies to the operator, the administrator, and the server; and
revoking the authorization of the operator to operate the asset.

5. The method of claim 1, further comprising
receiving, by the server, a login request from the operator prior to receiving the input data from the operator, wherein the login request comprises login credential details of the operator; and
validating, by the server, the login request based on the login credential details entered by the operator.

6. The method of claim 5, further comprising recording a video of the operator using a camera in real-time upon a successful validation of the login request.

7. The method of claim 5, further comprising performing an operator verification using the ML model, based on a biometric identification test and an operator Identification Document (ID) upon the successful validation of the login request.

8. The method of claim 1, further comprising:
storing the input data, the real-time video data, and a number of failed authorization attempts by the operator in a historical dataset associated with the operator; and
maintaining a past behaviour record of the operator in the operator profile based on the historical dataset associated with the operator using the ML model.

9. A system for intoxication examination of an operator for operating an asset, the system comprising:
a processor; and
a memory communicatively coupled to the processor, wherein the memory stores processor-executable instructions, which, on execution, cause the processor to:
receive input data corresponding to the operator prior to operating the asset from at least one of an asset or a client device, wherein the asset is in a locked state, and wherein in the locked state the asset is inaccessible by the operator;
determine an intoxication score of the operator based on the input data using a Machine Learning (ML) model;
determine, by the server and using the ML model, permissibility of operating an asset for the operator through a plurality of predefined rules based on:
the intoxication score of the operator, wherein the asset operation is permissible when the intoxication score of the operator is above a predefined threshold score required for operating the asset; and
a plurality of responses corresponding to an examination questionnaire received from the operator, wherein the examination questionnaire comprises a plurality of questions, and wherein the asset operation is permissible when the operator correctly answers more than a predefined threshold number of questions in the questionnaire;
assign, by the server, the asset to the operator when the asset operation is determined to be permissible for the operator;
transmit, by the server, authorization information to the assigned asset, wherein the authorization information comprises operator details, a class of the asset, conditions of operation, a validity period, an issuer, and checksum;
authorize, by the asset, the operator to operate the asset based on the authorization information, wherein upon successfully authorizing, the asset is in an unlocked state, and wherein in the unlocked state the asset is accessible by the operator; and
upon authorization, monitor in real-time, by the server, the operator during the asset operation from real-time video data of the operator to check for compliance of the asset operation with the conditions of operation.

10. The system of claim 9, wherein:
the input data comprises operator profile, video data of the operator, audio data corresponding to voice of the operator, and intoxication level of the operator estimated using a plurality of intoxication examination devices,
the operator profile comprises number of past failed authorization attempts of the operator, and
the video data of the operator comprises at least one of:
a video recording of the operator undertaking an intoxication examination with each of the plurality of intoxication examination devices, and
a video recording of the operator responding to one or more prompts via a User Interface (UI).

11. The system of claim 10, wherein the processor-executable instructions further cause the processor to
identify a position and an orientation of each of the operator and an intoxication examination device with respect to video frame from the video data of the operator through the ML model;
notify the operator to remain within the video frame when at least one of the operator and the intoxication examination device is out of the video frame; and
provide real-time recommendations to the operator to continue remaining within the video frame.

12. The system of claim 9, wherein the processor-executable instructions further cause the processor to monitor the operator in real-time by:
identify one or more anomalies in the asset operation; and
upon identification of the one or more anomalies, transmit a notification about the one or more anomalies to the operator, the administrator, and the server; and
revoke the authorization of the operator to operate the asset.

13. The system of claim 9, wherein the processor-executable instructions further cause the processor to:
receive a login request from the operator prior to receiving the input data from the operator, wherein the login request comprises login credential details of the operator; and
validate the login request based on the login credential details entered by the operator.

14. The system of claim 13, wherein the processor-executable instructions further cause the processor to record a video of the operator using a camera in real-time upon a successful validation of the login request.

15. The system of claim 13, wherein the processor-executable instructions further cause the processor to perform an operator verification using the ML model, based on a biometric identification test and an operator Identification Document (ID) upon the successful validation of the login request.

16. The system of claim 9, wherein the processor-executable instructions further cause the processor to:
store the input data, the real-time video data, and a number of failed authorization attempts by the operator in a historical dataset associated with the operator; and
maintain a past behaviour record of the operator in the operator profile based on the historical dataset associated with the operator using the ML model.

17. A non-transitory computer-readable medium storing computer-executable instructions for intoxication examination of an operator for operating an asset, the computer-executable instructions configured for:
receiving input data corresponding to the operator prior to operating the asset from at least one of an asset or a client device, wherein the asset is in a locked state, and wherein in the locked state the asset is inaccessible by the operator;
determining an intoxication score of the operator based on the input data using a Machine Learning (ML) model;
determining, using the ML model, permissibility of operating an asset for the operator through a plurality of predefined rules based on:
the intoxication score of the operator, wherein the asset operation is permissible when the intoxication score of the operator is above a predefined threshold score required for operating the asset; and
a plurality of responses corresponding to an examination questionnaire received from the operator, wherein the examination questionnaire comprises a plurality of questions, and wherein the asset operation is permissible when the operator correctly answers more than a predefined threshold number of questions in the questionnaire;
assigning the asset to the operator when the asset operation is determined to be permissible for the operator;
transmitting authorization information to the assigned asset, wherein the authorization information comprises operator details, a class of the asset, conditions of operation, a validity period, an issuer, and checksum;
authorizing the operator to operate the asset based on the authorization information, wherein upon successfully authorizing, the asset is in an unlocked state, and wherein in the unlocked state the asset is accessible by the operator; and
upon authorization, monitoring in real-time, the operator during the asset operation from real-time video data of the operator to check for compliance of the asset operation with the conditions of operation.

18. The non-transitory computer-readable medium of the claim 17, wherein:
the input data comprises operator profile, video data of the operator, audio data corresponding to voice of the operator, and intoxication level of the operator estimated using a plurality of intoxication examination devices,
the operator profile comprises number of past failed authorization attempts of the operator, and
the video data of the operator comprises at least one of:
a video recording of the operator undertaking an intoxication examination with each of the plurality of intoxication examination devices, and
a video recording of the operator responding to one or more prompts via a User Interface (UI).

19. The non-transitory computer-readable medium of the claim 18, wherein the computer-executable instructions configured for:
identifying a position and an orientation of each of the operator and an intoxication examination device with respect to video frame from the video data of the operator through the ML model;
notifying the operator to remain within the video frame when at least one of the operator and the intoxication examination device is out of the video frame; and
providing real-time recommendations to the operator to continue remaining within the video frame.

20. The non-transitory computer-readable medium of the claim 17, wherein the computer-executable instructions configured for:
identifying one or more anomalies in the asset operation; and
upon identification of the one or more anomalies, transmitting a notification about the one or more anomalies to the operator, the administrator, and the server; and
revoking the authorization of the operator to operate the asset.
